(19) United States
(12) Patent Application Publication
(10) Pub. No.: US 2002/0065668 A1
(43) Pub. Date: May 30, 2002

(54) Personal information protection method for a network kiosk

(75) Inventors: John C. Goodwin III, Suwanee, GA (US); John Brian Francis, Alpharetta, GA (US)

Correspondence Address: Paul W. Martin, NCR Corporation, Law Department, ECD-2, 101 West Schantz Avenue, Dayton, OH, 45479-0001, US

(73) Assignee: NCR Corporation

(21) Appl. No.: 09/727,332

(22) Filed: Nov. 29, 2000

(51) Int. Cl. G06F 17/60

(52) U.S. Cl. 705/1

(57) ABSTRACT

A personal information protection method for a network kiosk which hides the personal information and possibly eventually removes it from a web page. The method includes the steps of determining a field in the web page capable of accepting the personal information, determining entry of the personal information into the field by an operator, timing a time period, and preventing access to the personal information following the time period.

### BACKGROUND OF THE INVENTION

The present invention relates to self-service kiosks and more specifically to a personal information protection method for a network kiosk.

Retailers have a desire to sell their products over global networks, such as networks which are a part of the World Wide Web (WWW or “web”) and which use the Transmission Control Protocol/Internet Protocol (TCP/IP protocol). These retailers wish to provide Internet server web sites which offer the same features as Internet server web sites available to home shoppers who use their computers to connect to the Internet server web sites.

Kiosks provide a publicly-accessible computing platform for displaying web pages from retailer web sites. Kiosks may be located within a retailer's transaction establishment or elsewhere, such as in shopping malls. Kiosks may be easily networked to retailer web sites using the TCP/IP protocol. Web pages from web sites may be displayed using known and available web software, such as Microsoft® Internet Explorer software.

One problem which distinguishes home use from public use is the possibility that personal information entered by an operator of a public kiosk will be compromised to a subsequent operator. Web pages for processing transactions typically contain fields which require entry of the purchaser's personal information, such as name, address, phone, and credit card information Since such information may be cached in memory or in fixed disks within the kiosk. After an operator leaves a kiosk, a subsequent operator may be able to view the former operator's personal information on a currently-displayed web page, and possibly previously displayed pages.

Therefore, it would be desirable to provide a personal information protection method for a network kiosk which minimizes the risk of revealing personal information to a subsequent kiosk operator.

### SUMMARY OF THE INVENTION

In accordance with the teachings of the present invention, a personal information protection method for a network kiosk is provided.

The method includes the steps of determining a field in the web page capable of accepting the personal information, determining entry of the personal information into the field by an operator, timing a time period, and preventing access to the personal information following the time period.

It is accordingly an object of the present invention to provide a personal information protection method for a network kiosk.

It is another object of the present invention to remove personal information from display after the operator who entered the information has left the kiosk.

It is another object of the present invention to prohibit access to personal information after a predetermined time period of display unless a password has been entered by the operator.

### BRIEF DESCRIPTION OF THE DRAWINGS

Additional benefits and advantages of the present invention will become apparent to those skilled in the art to which this invention relates from the subsequent description of the preferred embodiments and the appended claims, taken in conjunction with the accompanying drawings, in which:

FIG. 1 is a block diagram of a transaction processing system including a network kiosk;

FIG. 2 is a depiction of a security configuration file; and

FIG. 3 is a flow diagram illustrating the information protection method of the present invention.

### DETAILED DESCRIPTION OF THE PREFERRED EMBODIMENT

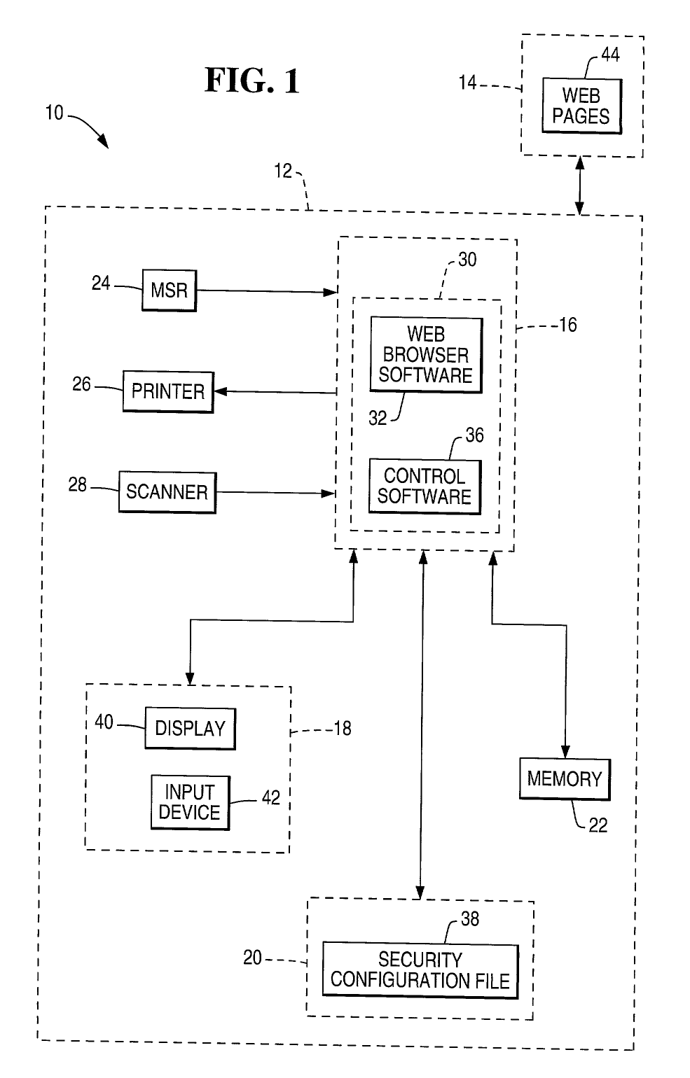

Turning now to FIG. 1, transaction system 10 includes kiosk 12 and network 14. Kiosk 12 is preferably located within a transaction establishment, such as a retail store, or transaction environment, such as a shopping mall. Kiosk 12 may include an NCR 7401 computer.

Kiosk 12 primarily includes processor 16, touch screen 18, memory 20, and storage medium 22. Kiosk 12 may additionally include a number of peripherals, including magnetic strip reader (MSR) 24, printer 26, and scanner 28.

To assist with execution of certain tasks performed by kiosk 12, kiosk 12 includes a built-in time keeping device, commonly referred to as a system clock, which is synchronized with current time, in order to automatically execute the tasks at their scheduled times.

Processor 16 controls operation of kiosk 12 and executes web wrapper software 30.

Web wrapper software 30 allows an operator to access information and purchase products from the transaction establishment. Web wrapper software 30 includes web browser software 32 and control software 36.

Web browser software 32 may include commercially-available web browser software, such as Microsoft® Internet Explorer web browser software Microsoft® Internet Explorer web browser software is configured into a web wrapper operation using a “-k” command line option. This option hides toolbars and menubars to prevent operator access to those functions.

Web browser software 32 retrieves and displays web pages 44 from network 14, which includes a plurality of interconnected servers. Web pages 44 include web pages which display information about products and services offered by the kiosk owner as well as other web pages. Web pages 44 are tailored to the needs of the transaction establishment. Web pages 44 assist operators to find information about products sold by the transaction establishment and to complete purchases of such products. For this purpose, web pages 34 may include a start or “home” page which operates as a default page from which operation begins and to which operation returns when an operator is finished using kiosk 12. Web pages 44 may be written using hypertext markup language (HTML) or other suitable web page language.

Control software 36 provides security functions. During operation, control software 36 prevents an operator from accessing kiosk files, other applications, the operating system software, or basic input-output system (BIOS) firmware, and prevents the operator from causing kiosk 12 to reboot.

Under the present invention, control software 36 additionally removes personal information in web pages following a predetermined time interval after operator entry, in order to prevent access to such information by subsequent operators.

It is a feature of the present invention that the time interval varies by type of information, by the page currently displayed, or by the current stage of a transaction. For example, name, address, or phone number entries may be set by the retailer to a different time interval than credit card number entries. Time interval information may be coded into web wrapper software 36 or listed in security configuration file 38 to allow a kiosk owner to control operation.

Touch screen 18 includes display 40 and input device 42. Display 40 and input device 42 may also be separate units. Input device 42 may record personal information from an operator and insert it into a web page field.

Memory 20 is used by processor 16 to store executed program information, including web wrapper software information. As such, memory 20 may store personal information entered by an operator. Control software 36 removes any personal information from memory 22 before canceling operation and returning to the start page.

Storage medium 22 stores software including web wrapper software 30. Storage medium 22 may additionally operate as cache or virtual memory, and as such, store personal information entered by an operator. Control software 36 removes any personal information and files containing personal information from storage medium 22 before canceling operation and returning to the start page.

MSR 24 reads loyalty, credit, debit, SMART, and/or other types of cards carried by an operator. MSR 24 may record personal information from an operator and insert it into a web page field.

Printer 26 prints information from web wrapper software 32, including information on web pages 44 from network 14. For example, printer 26 may print information relevant to a transaction completed by an operator using kiosk 12.

Scanner 28 reads bar codes on products to obtain product identification numbers. Kiosk 12 queries a transaction server with the identification numbers to obtain information about the product and displays the information.

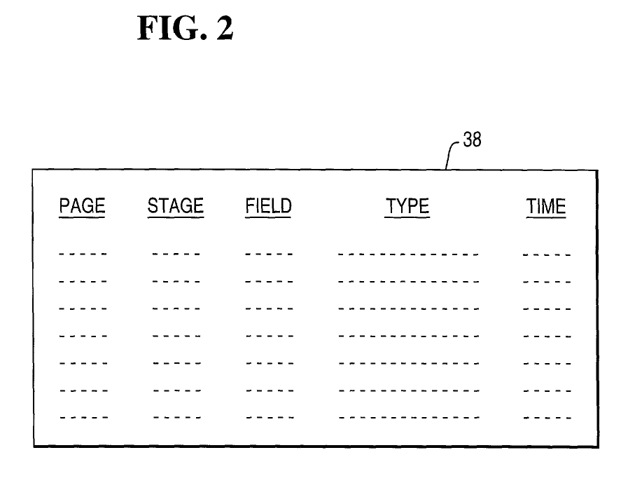

Turning now to FIG. 2, security configuration file 38 includes entries PAGE, STAGE, FIELD, INFORMATION, and TIME.

Entry PAGE identifies a particular web page which accepts personal information entries. Web page addresses or Uniform Resource Locators (URLs) are preferably stored. All pages of web pages 44 which accept personal information entries are listed in security configuration file 38.

Entry STAGE identifies a stage of a transaction represented by the corresponding page. Entry STAGE is an arbitrary scale established by the retailer.

Entry FIELD identifies a specific entry field on a corresponding page.

Entry TYPE identifies the type of personal information which the corresponding field stores.

Entry TIME identifies a period of inactivity for the corresponding personal information. Timeout periods may vary by page, stage, or field. The retailer can choose a timeout value for each record based upon the information it contains.

For example, if the operator is looking for information and has not identified any items for purchase, then a longer timeout period is established. If items have been identified for purchase, a shorter time may be warranted. Finally, if personal information has been entered, an even shorter time may be warranted.

Control software 36 compares each displayed web page 44 with entries PAGE in security configuration file 38 and initializes entries TIME of those pages which are listed.

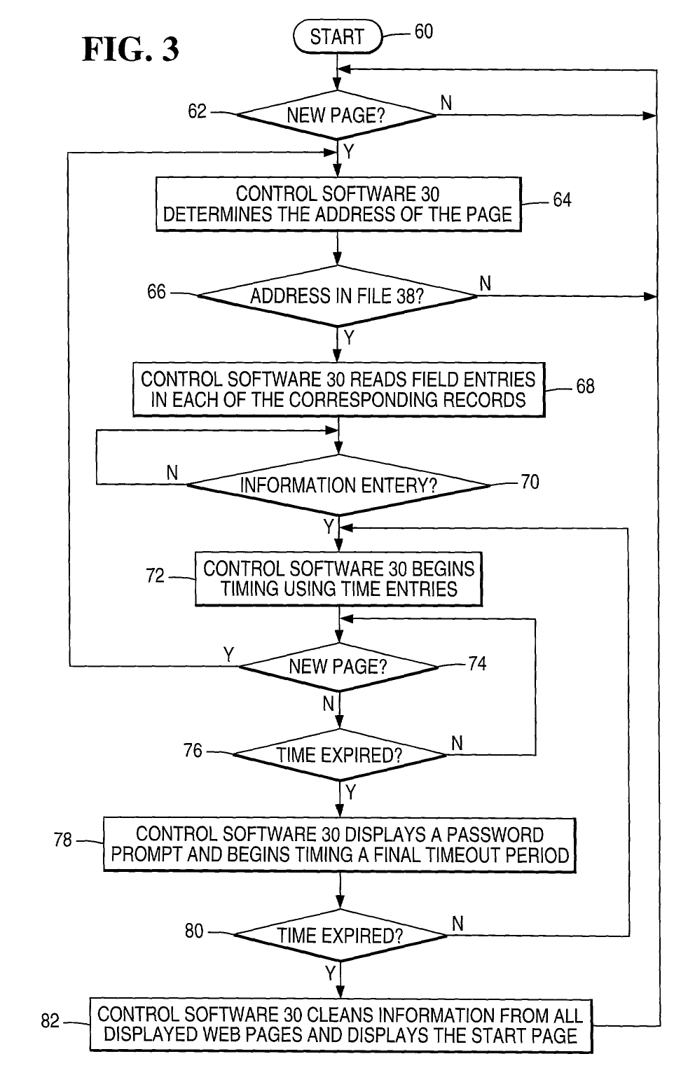

Turning now to FIG. 3, the method of the present invention is illustrated beginning with START 60.

In step 62, control software 36 waits for a page to be displayed. Preferably, pages are displayed to provide information and to walk a customer through a transaction.

In step 64, control software 36 determines the address or Uniform Resource Locator (URL) of the page. Control software 36 temporarily stores the address of this page and subsequent pages in memory 22 or storage medium 20 until a transaction is complete or until a time period for any of the fields on a web page have expired.

In step 66, control software 36 compares the address to the addresses in security configuration file 38. If the address of the page is in one or more of the records in security configuration file 38, operation proceeds to step 68, otherwise operation returns to step 62 to wait for another page to be displayed.

In step 68, control software 36 reads entry FIELD in each of the corresponding records.

In step 70, control software 36 begins simultaneous monitoring of all fields in the page for entry of information by an operator. If control software 36 determines that web browser software 32 has recorded information into the fields, operation proceeds to step 72 for those fields containing information. Otherwise, control software 36 waits for information entry in fields which do not contain information.

In step 72, control software 36 begins timing using time entries from file 38 following entry of information into the fields. For web pages with multiple field entries, timing of some or all fields may overlap or occur sequentially.

In step 74, control software 36 monitors for display of a new page. If a new page is displayed before expiration of any of the time periods, operation returns to step 64.

In step 76, control software 36 waits for expiration of the time periods. Operation proceeds to step 78 if any of the time periods has expired.

In step 78, control software 36 displays a password prompt to the operator and begins timing a final timeout period. Control software 36 gives the operator chance to establish that he is still using kiosk 12.

Control software 36 derives the password from all or part of any private information entered by the operator on the currently displayed page or any previously displayed page. For example, control software 36 may pick a field with entered information which happens to include a phone number. Control software 36 recalls the entered information and obtains the field type from file 38. Control software 36 prompts the operator to enter all or part of the information by displaying a message containing the field type, such as “enter phone number”. Previously entered address and name information are additional example sources for passwords.

In step 80, control software 36 waits for the time to expire. If the operator fails to enter a password, operation proceeds to step 82. Otherwise, operation returns to step 72 to reinitialize timing.

In step 82, control software 36 cleans information from the fields on the web page in use and fields in previously displayed web pages and redisplays the start page. Operation then returns to step 62 to await the next operator.

Although the present invention has been described with particular reference to certain preferred embodiments thereof, variations and modifications of the present invention can be effected within the spirit and scope of the following claims.

We claim:

1. A method of protecting personal information in a web page displayed by a networked kiosk comprising the steps of:
determining a field in the web page capable of accepting the personal information;
determining entry of the personal information into the field by an operator;
timing a time period; and
preventing access to the personal information following the time period.

2. The method as recited in claim 1, further comprising the step of:
stopping timing if a new web page is displayed before the time period has expired.

3. The method as recited in claim 1, further comprising the steps of:
displaying a password prompt to the operator;
recording entry of a correct password by the operator;
timing a new time period; and
providing access to the personal information until the new time period has expired.

4. The method as recited in claim 3, further comprising the step of:
determining the correct password from the personal information.

5. The method as recited in claim 1, further comprising the step of:
cleaning information from the field.

6. The method as recited in claim 5, further comprising the step of:
displaying a start page.

7. A method of protecting personal information in a web page displayed by a networked kiosk comprising the steps of:
determining an address of the web page;
comparing the address to a list of addresses;
if the address is in the list of addresses,
determining a field in the web page capable of accepting the personal information;
determining entry of the personal information into the field by an operator;
timing a time period; and
preventing access to the personal information following the time period.

8. A network kiosk comprising:
a display for displaying a web page;
an input device for recording personal information from an operator; and
a computer which determines a field in the web page capable of accepting the personal information, determines entry of the personal information into the field by the operator, times a time period, and prevents access to the personal information following the time period.
